(19) United States
(12) Patent Application Publication
(10) Pub. No.: US 2025/0389388 A1
(43) Pub. Date: Dec. 25, 2025

(54) PROCESS FOR SUB-COOLING CO2 USING A FATAL CRYOGENIC LIQUID

(71) Applicant: L'Air Liquide, Société Anonyme pour I'Etude et I'Exploitation des Procédés Geore Claude, Paris (FR)

(72) Inventors: Franck COUSIN, Saint Brevin les Pins (FR); Etienne CHAVRE, Wiler (CH); Didier PATHIER, Shanghai (CN)

(21) Appl. No.: 19/243,508

(22) Filed: Jun. 19, 2025

(30) Foreign Application Priority Data
Jun. 20, 2024 (FR) FRFR2406635

(51) Int. Cl. F17C 7/02

(52) U.S. Cl. CPC F17C 7/02; F17C 2205/0352; F17C 2221/013; F17C 2221/014; F17C 2223/0161; F17C 2223/033; F17C 2227/0337

(57) ABSTRACT

A process for supplying sub-cooled liquid CO₂ to a site comprising a user station for the liquid CO₂, from a liquid CO₂ storage tank, which site contains a source of liquid nitrogen that is able to supply gaseous nitrogen to a user station for the gaseous nitrogen.

### CROSS REFERENCE TO RELATED APPLICATIONS

This application claims the benefit of priority under 35 U.S.C. § 119(a) and (b) to French Patent Application No. FR2406635, filed Jun. 20, 2024, the entire contents of which are incorporated herein by reference.

### BACKGROUND

The present invention relates to the field of supplying liquid or solid CO2 to processes using such a fluid.

Mention may be made here of dry ice production plants, which are also traditionally centers for filling cylinders or racks of cylinders with the gas. But mention may also be made of industrial users of liquid CO₂ or dry ice, for example for the low injection cooling of food products (kneaders, meat blenders, etc.) or for stations carrying out machining operations (machining, cutting, etc.), these only being examples from a large number of industrial applications.

In the case of machining, the cryogen is used not only to cool the zone but also to have a “lubricating” effect on the cutting tools.

A cryogenic liquid is commonly understood to be fluid which, at atmospheric pressure, is liquid at a temperature far below 0° C.

Such a cryogenic liquid (for example liquid nitrogen) is traditionally supplied to a consumer equipment item, regardless of its type, from a cryogenic fluid tank connected to the consumer equipment item for this fluid, said tank containing, under a storage pressure higher than atmospheric pressure, a cryogenic fluid which is in the liquid phase at the bottom of the tank and in the gaseous phase at the top of the tank, this tank being designed both to supply the consumer equipment item with liquid withdrawn from the bottom of the tank and to be supplied with fluid from the outside.

Use is made most commonly in industry of so-called “low storage pressure” tanks, i.e. those in which the maximum pressure achieved at the top of the tank is generally lower than around 4 barg, but, depending on the intended applications, so-called “medium pressure” storage tanks that achieve up to 15 barg, or even so-called high pressure storage tanks that achieve up to 30 barg, are also found.

Since the storage pressure of the tank is higher than atmospheric pressure, the opening of a valve placed on the pipe connecting the tank to the consumer equipment item (for example a machine tool or a food blender) causes the liquid to move from its drawing point to its point of use, without a forced drive means and in spite of the pressure losses on the line (valves, bent portions etc.).

In order to ensure that the driving of the cryogenic liquid is always effective regardless of the level of liquid in the tank, the pressure of the gas at the top of the tank is conventionally regulated such that this pressure remains substantially equal to a predetermined, fixed value, for example around 2 to 4 bar.

However, the pressure of the liquid at the bottom of the tank varies depending on the height of the liquid inside the tank, such that, as the liquid level drops, the pressure of the liquid withdrawn drops and tends to approach the pressure of the gas at the top. For example, in the case of nitrogen, a liquid height of around 10 meters implies a pressure difference of around 0.6 bar between the gas pressure at the top and the liquid pressure at the bottom of the tank, at the drawing point. In the case of a pressure at the top of the tank regulated to 3 barg, the pressure at the bottom of the tank, i.e. the pressure of the cryogenic liquid in the pipes, will vary from 3.6 barg when the tank is full to 6 barg when the tank is empty.

This variation in pressure of the liquid at the drawing point necessarily leads to a variation in the flow rate of liquid withdrawn, bringing about disturbances in the operation of the consumer equipment item situated downstream. A symmetric effect occurs during the resupplying of the tank with fluid.

For well-known reasons of better “cryogenic quality” in terms of available cold energy, the literature and these industries that make use of cryogens have become interested in means for supplying these user stations with pure or substantially pure liquid or with sub-cooled liquid, that is to say with liquid at a reduced pressure, and at a temperature lower than when it was at a higher pressure.

Specifically, considering the example of machining, the higher the spraying pressure in the machining zone, the better the coefficients of heat exchange. However, when the cryogen, for example liquid nitrogen, is sprayed, gas is created (on account of its expansion) at the outlet of the spray nozzle. The quantity of gas generated is directly proportional to the temperature and pressure of the liquid nitrogen upstream of the nozzle. The advantage of endeavoring to have a sub-cooled liquid will therefore be understood.

Certain studies have recommended the use of phase separation (degassing) means on the line connecting the tank to the consumer equipment item; reference could be made, for example, to the document EP-2 347 855.

Other solutions have proposed coupling two tanks and of using them alternately after filling and depressurization. The drawbacks of this solution are very clearly the very great handling that is brought about and the mobilization of two tanks.

Another solution is to insert a heat exchanger (for example a plate heat exchanger) just upstream of the point of use: the liquid nitrogen to be cooled (typically originally at 3 bar and a temperature of around −185° C.) circulates in one of the paths of the exchanger (main circuit), while a depressurized nitrogen, typically at a pressure of around 1 bar and a low temperature, around −196° C., circulates in another path of the exchanger. It is the exchange between these two paths, concurrently or counter-currently, that will make it possible to sub-cool the nitrogen in the main circuit. However, controlling the temperature is difficult to manage and stabilize here, in particular when the consumer equipment item downstream operates discontinuously, obliging the exchanger to pass through phases of heating and recooling, etc.

It is also possible to sub-cool the cryogen in an exchanger by mechanical cooling, and this is a solution for sub-cooling liquid CO₂ that has now become conventional and widespread.

Reference could also be made to the document WO2004/00 5791 in the name of the Applicant, which recommends varying the pressure of the gas at the top of the tank depending on the state of operation of this tank (consumption phase of the downstream user installation, or standby phase, or phase of supplying the tank with cryogenic liquid), and which rightly recommends, according to one of its embodiments, venting the tank during the standby periods. In other words, when the tank is not subjected to withdrawal operations and will not be a priori for a significant period of time, for example several hours (for example overnight), a control unit orders the opening of a valve for venting the top part of the tank. The gas pressure at the top of the tank then passes from a storage value to a value substantially equal to atmospheric pressure (residual pressure of a few hundred grams). Thus, by lowering the nitrogen storage pressure in this way, the cryogenic fluid will equalize to atmospheric pressure, meaning that it will partially vaporize until it reaches its equilibrium temperature at atmospheric pressure. It will then be colder than when it was under pressure. The fluid thus stored during these periods of non-use of the tank therefore has a temperature lower than the usual, ensuring a better cryogenic quality in terms of available cold energy. In fact, rapid repressurization (using, for example, its own atmospheric heater or the like) makes it possible to use the sub-cooled liquid.

Nevertheless, this solution is not without drawbacks, this venting necessarily involves losses, and furthermore the paradox of this procedure lies in the need for repressurization in order for it to be possible to use the nitrogen, and therefore to let in heat. Experimentation of this solution has, in particular, demonstrated a vaporization of 4 to 9% of the volume stored. Since this vaporization is not exploited, the cost has a direct impact on the user site. In sum, two major drawbacks of this venting solution are inferred therefrom:
1) The use of nitrogen that is not able to be exploited for repressurization.
2) The inlet of a hot gas into the storage tank for depressurization and the creation of a thermal bridge.

Consideration has also been given to supplying the user station, for example a machining station, directly from a cryogen storage tank at medium or high pressure, but then the creation, at the outlet of the spray nozzle, of a large quantity of gas is observed, this gas reducing exchanges of heat.

Lastly, consideration may be given to supplying the downstream user machine from a low pressure storage tank and through a pump, but the difficulties associated with the handling of such pumps are known, and added to these is the impossibility of supplying several machining stations of a single site at different pressures and at a low flow rate.

Returning now to the field of sub-cooled CO₂, consideration may be given to sub-cooling the CO2 via a drop in pressure: the sudden expansion of the liquid CO2 below 5.18 bar (triple point pressure) causes the formation of dry ice and gas at a temperature of −78.5° C. when the pressure is equal to atmospheric pressure.

The proportion of dry ice and gas depends on the initial state of the liquid and is provided by the curves of the mass proportions of gas in the Mollier diagram.

However, as mentioned above, liquid CO₂ is currently commonly cooled by mechanical cooling in an exchanger (exchange with a refrigerant).
liquid CO₂ at −20° C./20 bar gives (in % by mass) 47% solid and 53% gas.
liquid CO₂ at +20° C./58 bar gives (in % by mass) 29% solid and 71% gas.
when the temperature of the liquid CO₂ is reduced by one degree at 19 barg, dry ice production is increased by 0.36%.
to increase dry ice production by 1%, 5.7 kJ of cold has to be supplied per kg of liquid CO₂.
in addition, every kg of dry ice gained costs 570 kJ or 0.16 kWh.

In sum, the production of solid CO₂ from liquid CO₂ at 20 bar is characterized by a maximum yield of 47%. This means that 100 kg of liquid CO₂ is converted into 47 kg of usable solid CO₂ (dry ice) but also 53 kg of gas. This CO₂ in gaseous form is therefore lost and is passes into the atmosphere.

It will be understood that the increase in this yield would make it possible to consume less liquid CO₂ and therefore to reduce the cost of producing dry ice.

The following comparison of observable gains for the sub-cooling of CO₂ can then be made, using the following assumptions: 145 euro/tonne of liquid CO₂, and electricity at 0.1 euro per kWh.

In normal use: to produce 470 kg of CO₂ dry ice, 1000 kg of liquid CO₂ is required, i.e. a cost of 145 euro.

For cooling to −30° C., a pressure of 19 or 13 barg (20 or 14 bara) (the gain is the same regardless of the pressure): 145.4 euro for 506 kg of CO₂ dry ice.

To produce 470 kg of CO₂ dry ice, it therefore takes 145.4/506×470=135 euro (7% saving compared with 145 euro).

For cooling to −40° C., a pressure of 19 or 9 barg (20 or 10 bara) (the gain is the same regardless of the pressure): 146.3 euro for 540 kg of CO₂ dry ice.

To produce 470 kg of CO₂ dry ice, it therefore takes 146.3/540×470=127 euro (12% saving compared with 145 euro).

For cooling to −50° C., a pressure of 19 or 6 barg (20 or 7 bara) (the gain is the same regardless of the pressure): 149 euro for 580 kg of CO₂ dry ice.

To produce 470 kg of CO₂ dry ice, it therefore takes 149/580×470=121 euro (18% saving compared with 145 euro).

### SUMMARY

As will be seen in more detail in the following text, the present invention proposes improving the existing processes for sub-cooling liquid CO₂, and therefore supplying such sub-cooled CO₂ to a user station, with the objective of obtaining a cost of sub-cooled liquid CO₂ that is not higher than that currently supported by industrial users, or even lower, but also with a smaller carbon footprint.

To this end, the present invention proposes cooling the liquid CO₂ not with a mechanical cooling system as is currently used, but in an exchanger implementing heat exchange between CO₂ and liquid nitrogen that can be described as “fatal”.

For this purpose, the exchange takes place with liquid nitrogen that is otherwise present on the site, because another application of this site requires gaseous nitrogen resulting from the vaporization of this liquid nitrogen (for example to produce gaseous nitrogen for packaging food products under a modified atmosphere).

The cooling is advantageously carried out in the immediate vicinity of the liquid CO₂ storage tank and in the vicinity of the liquid nitrogen storage tank.

The cooling of the CO₂ advantageously occurs when the consumption of gaseous nitrogen by the application in question is activated (nitrogen gas demand); by contrast, the cooling of CO₂ is not necessarily synchronized with the need for sub-cooled CO₂ and therefore with the need for cooling.

In other words, the CO₂ is cooled by the vaporization of the liquid nitrogen advantageously when there is a demand for gaseous nitrogen consumption at the consumer station of this nitrogen; then, this sub-cooled CO₂, if it is not called upon immediately for the downstream need, is stored in the CO₂ storage tank, thereby lowering the pressure of the tank.

Subsequently, when the consumption of sub-cooled CO₂ begins, the CO₂ is drawn from the already sub-cooled tank.

In sum, therefore:
it is necessary according to the invention for there to be consumption of gaseous nitrogen on site in order for it to be possible to sub-cool the CO₂.
on the other hand, the invention can be implemented in the two following scenarios (i.e. pausing or non-pausing of CO₂ consumption):
   the consumptions of CO₂ and nitrogen are synchronized and therefore advantage is taken of this state of affairs to sub-cool the CO₂ extracted from the storage tank in order to send it to the CO₂ consumer station;
   the site is in the nitrogen consumption phase but the consumption of CO₂ has been stopped (pause): advantage is therefore taken of this state of affairs to cool the mass of CO₂ present in the CO₂ storage tank (cold inertia is generated).
The gaseous nitrogen resulting from the heat exchange between the liquid CO₂ and the liquid nitrogen is sent to the gaseous nitrogen demand of the site but preferably passes beforehand through an exchanger of the atmospheric evaporator type, to better ensure that this nitrogen has completely changed state and is not too cold, which would risk weakening the transport pipes or disturb the end-user process.
when the consumption of sub-cooled CO₂ begins in the user station for this CO₂ and the client is also consuming nitrogen, the CO₂ is drawn from the already sub-cooled tank (for example in the vicinity of −30° C.) and if this already very cold state is acceptable on initial examination, the present invention proposes cooling this taken CO₂ even further, by carrying out second cooling, using this same cold fatal nitrogen, preferably passing through the same exchanger, in order to achieve lower temperatures, for example in the vicinity of −50° C.

In addition, it is preferable to continue to lower the temperature of this CO₂ not in the storage tank but in line in the exchanger, in order, for safety reasons, to avoid the temperature, and therefore the pressure, in the storage tank itself dropping too low. It is therefore preferred to “complete” the drop in temperature just before the CO₂ end-use station.
The implementation of the heat exchanger according to the invention therefore makes it possible both to sub-cool the CO₂ in the cryogenic tank in a first operation and to sub-cool the CO₂ towards the use of this CO₂ in a second operation, with different temperatures.

The advantages of the present solution can be summarized as follows:
This system makes it possible, as it were, to store the cold energy usually lost during the vaporization of nitrogen and then to reuse it in the form of cold with a greater production of dry ice.
Without using electrical energy, this system makes it possible to produce more cold by increasing the production yield of dry ice. In other words, the energetic power of the molecule increases, this CO₂ will deliver more cold energy and the production of dry ice will be greater.
Furthermore, the carbon footprint of this technical solution is reduced: the carbon footprint is reduced proportionally to the reduction in CO₂ consumption. This means that, for every tonne of CO₂ that is not output, the carbon footprint is reduced by one tonne.
The cooler can be installed outside the production workshop and thus will not disturb the production.

### DETAILED DESCRIPTION OF PREFERRED EMBODIMENTS

The present invention thus relates to a process for supplying sub-cooled liquid CO₂ to a site comprising at least one user station for this liquid CO₂, from a CO₂ storage tank, which tank contains, under a storage pressure higher than atmospheric pressure, the cryogenic fluid in the liquid phase at the bottom of the tank and in the gaseous phase at the top of the tank, said tank being designed to supply said CO₂ user station with liquid withdrawn from the bottom of the tank, and to be supplied with fluid from the outside, characterized in that:
a source of liquid nitrogen capable of supplying gaseous nitrogen to a user station for this gaseous nitrogen is provided within the site;
when the consumptions of CO₂ and nitrogen are not synchronized, when there is consumption of nitrogen but no consumption of CO₂, first cooling of liquid CO₂ taken from said CO₂ storage tank is arranged, by heat exchange in an exchanger with liquid nitrogen taken from said nitrogen storage tank, and the CO₂ thus sub-cooled to a first temperature is returned to the CO₂ storage tank, the taking and exchange being carried out when there is a demand for gaseous nitrogen consumption by said nitrogen user station and not for CO₂ consumption at the same time;
when the consumptions of CO₂ and nitrogen by said user stations are synchronized, when there is a demand for consumption by the consumer station for sub-cooled CO₂ and a demand for gaseous nitrogen, liquid CO₂ is taken from said CO₂ storage tank and second cooling is carried out on this taken CO₂, by heat exchange in said exchanger with liquid nitrogen taken from said nitrogen storage tank, in order to lower the temperature of the taken liquid CO₂ to a second temperature, which is lower than the first temperature, and then the liquid CO₂ sub-cooled to this second temperature in this way is directed to the user station of liquid CO₂.

According to one of the embodiments of the invention, the gaseous nitrogen resulting from the heat exchange between the liquid CO₂ and liquid nitrogen carried out during the first or second cooling operation is, before being directed to the nitrogen user station of the site, sent through an exchanger, for example of the atmospheric evaporator type, in order to better ensure that this nitrogen has completely changed state and is not too cold, which would risk weakening the transport pipes or disturbing the process of said user station of this nitrogen.

According to one of the embodiments of the invention, a cryogenic pump is used, during a cooling operation in the exchanger, to circulate the liquid CO₂ in the exchanger. Specifically, discharging the sub-cooled CO₂ in the gas phase would risk causing the storage pressure to drop too rapidly.

The reason why the presence of this pump (or “circulator”) is very important for the proper functioning of the invention will be explained in the following text.

Specifically, it may be considered that when there is consumption of nitrogen but not consumption of CO₂, it is necessary, in this case, to take CO₂ (and therefore to “pump” CO₂) from the tank, circulate it in the exchanger and then return it to the tank, and therefore the pump can be considered to be used as a “circulator” in this case.

A concept well known to those skilled in the art relating to the functions of pump and circulator will be recalled.

The two terms “pump” and “circulator” are often used interchangeably, but there are subtle differences between the two, in particular in the field of energy transfer.

A “pump” draws fluid from a low pressure point and pushes it to a high pressure point. It can create a significant pressure difference and transport the fluid over great distances. Pumps are available in a wide variety of types and sizes, each being designed for a specific purpose.

A “circulator” is a type of pump designed to circulate a fluid in a closed circuit. It does not generally create as much of a pressure difference as a pump, but it does make it possible to maintain a constant circulation of fluid in the system. Circulators are often used in heating and air-conditioning systems.

Therefore, in the context of the present invention, although the presence of such a circulator may not appear to be essential when the exchange is carried out at the time of the use of CO₂ towards its application (2d exchange), this presence is highly recommended in exchange No 1 returning the sub-cooled CO₂ to the CO₂ storage tank.

Specifically, in an energy transfer circuit, a circulator plays a crucial role in optimizing the circulation of the fluid to be cooled and ensuring efficient distribution of the cold energy:
the circulator creates a driving force that propels the fluid (CO₂) through the circuit (exchanger), overcoming the hydraulic resistance of the pipes, valves and other components. Without a circulator, the natural circulation of the fluid would be slow and insufficiently efficient, resulting in uneven distribution of cold energy and average or mediocre performance of the system.
However, adequate circulation allows faster and more uniform transfer of cold between the source (CO₂ storage tank) and the emitters of cold energy (cryogenic nitrogen exchanger). This translates into better energy efficiency of the sub-cooling system, thereby reducing (electrical) energy consumption and operating costs.
The circulator ensures that the cold is evenly distributed in all parts of the circuit.
A circulator can also be considered to be very advantageous for protecting the exchanger from damage caused by excessive sub-cooling. This is because insufficient circulation can cause excessive build-up of cold in the exchanger, and this may impair its operation and shorten its service life.
Furthermore, in modern transfer systems, the circulator can be controlled by a thermostat or any other control system for adjusting the circulation speed depending on the cold demand. This makes it possible to optimize the nitrogen demand for reaching the target CO₂ temperature.

In sum, the use of a circulator in such an energy transfer circuit is really very advantageous for ensuring efficient circulation of the CO₂ fluid, uniform distribution of the cold, better energy efficiency and protection of the equipment.

The pump (circulator) is therefore, for example, actuated by a temperature sensor indicating the temperature of the liquid in the CO₂ storage tank, for example close to −30° C.

The case where the temperature of the liquid CO₂ required by the user station of the site is close to −50° C. will be considered.

In order not to reach excessively low temperatures in the exchanger (below −50° C.), a flow sensor for liquid CO₂ allows the exchanger to be put into operation.

Reference herein to “one embodiment” or “some embodiments” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used herein, the indefinite article “a” or “an” means one or more.

As used herein, “about” or “around” or “approximately” in the text or in a claim means ±10% of the value stated.

The standard abbreviations of the elements from the periodic table of elements are used herein. It should be understood that elements may be referred to by these abbreviations (e.g., Si refers to silicon, N refers to nitrogen, O refers to oxygen, C refers to carbon, etc.).

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A process for supplying sub-cooled liquid CO₂ to a site comprising at least one user station for the liquid CO₂, from a CO₂ storage tank, which tank contains, under a storage pressure higher than atmospheric pressure, a cryogenic fluid in liquid phase at the bottom of the tank and in gaseous phase at the top of the tank, the tank being designed to supply the at least one user station with the cryogenic liquid withdrawn from the bottom of the tank, and to be supplied with a fluid of the cryogenic liquid from the outside, wherein:
a source of liquid nitrogen capable of supplying gaseous nitrogen to a user station for the gaseous nitrogen is provided within the site;
first cooling of liquid CO₂ taken from the CO₂ storage tank is arranged, by heat exchange in an exchanger with liquid nitrogen taken from a nitrogen storage tank, and the CO₂ thus sub-cooled to a first temperature is returned to the CO₂ storage tank, the taking and exchange being carried out when there is a demand for gaseous nitrogen consumption by the nitrogen user station;
the consumptions of CO₂ and nitrogen by the user stations being able or unable to be synchronized, and in that when they are not synchronized, when there is a demand for consumption by a consumer station for sub-cooled CO₂, liquid CO₂ is taken from the CO₂ storage tank and second cooling is carried out on the taken CO₂ by heat exchange in the exchanger with liquid nitrogen taken from the nitrogen storage tank, in order to lower the temperature of the taken liquid CO₂ to a second temperature, which is lower than the first temperature;
then, the liquid CO₂ cooled in this way to the second temperature is directed to the user station of the liquid CO₂.

2. The process according to claim 1, wherein the gaseous nitrogen resulting from the heat exchange between the liquid CO₂ and liquid nitrogen carried out during the first or second cooling operation is, before being directed to a gaseous nitrogen user station of the site, sent through the exchanger in order to better ensure that the gaseous nitrogen has completely changed state and is not too cold, which would risk weakening transport pipes or disturbing a process of the gaseous nitrogen user station.

3. The process according to either of claims 1 and 2, wherein a cryogenic pump of a circulator type is used, during one or each of the cooling operations in the exchanger, to circulate the liquid CO₂ in the exchanger and, if necessary, return it to the CO₂ storage tank.

4. The process according to claim 2, wherein the exchanger is an atmospheric evaporator type.
